(19) United States
(12) Patent Application Publication
(10) Pub. No.: US 2011/0094667 A1
(43) Pub. Date: Apr. 28, 2011

(54) Method for producing strip laminates

(75) Inventors: Rainer Schulze, Hamburg (DE); Michael Evers, Guderhandviertel (DE); Nils Czerwonatis, Hamburg (DE)

(73) Assignee: TESA SE, Hamburg (DE)

(21) Appl. No.: 12/993,757

(22) PCT Filed: Aug. 4, 2009
(86) PCT No.: PCT/EP2009/060095

§ 371 Date: Jan. 11, 2011

(30) Foreign Application Priority Data
Aug. 21, 2008 (DE) 10 2008 038 595.6

(51) Int. Cl. B32B 37/02; B32B 37/12; B32B 38/10; B32B 38/18

(52) U.S. Cl. 156/247; 156/538; 156/539

(57) ABSTRACT

The invention relates to a method for producing a strip laminate comprising a strip carrier material (1) and a first adhesive layer (4) on at least one of the surfaces of the strip carrier material (1). The method according to the invention comprises the following steps: (a) coating a first auxiliary strip carrier material (2) with at least the first adhesive layer (4) and winding up the coated first auxiliary strip carrier material (9) onto a first roll (8); (b) unwinding the coated first auxiliary strip carrier material (9) from the first roll (8) and guiding the coated first auxiliary strip carrier material (9) towards a first laminating roller (14); (c) laminating the coated first auxiliary strip carrier material (9) onto the strip carrier material (1) in such a manner that the first adhesive layer (4) faces the strip carrier material (1); and (d) delaminating the first auxiliary carrier material (2) from the first adhesive layer (4).

The invention relates to a method for producing tapelike laminates, to apparatus for carrying out the method, and to uses of the apparatus.

Tapelike laminates, more particularly single-sidedly or double-sidedly adhesive tapes, are produced in accordance with the prior art by means of a method which comprises generally three component steps. In the first component step, a pressure-sensitive adhesive is applied continuously to a tapelike liner material which is moving in its longitudinal direction. Subsequently, the liner material coated with the pressure-sensitive adhesive passes, in the second component step, through a drying apparatus, in which the pressure-sensitive adhesive on the liner material is dried. In the third component step, the top face of the pressure-sensitive adhesive, facing away from the liner material, is laminated with a tapelike carrier material, the carrier material being subjected, immediately prior to lamination, to a corona treatment. The resulting three-layer laminate, comprising the tapelike carrier material, the pressure-sensitive adhesive atop it, and the liner material atop that, is subsequently rolled up into a roll. This method can also be used to produce double-sided adhesive tapes.

This known method has a number of drawbacks. First, the productivity of lines of this kind is comparatively low, since the laminating in the third component step necessitates a lower web speed than is necessary for the coating in the first component step and the drying in the second component step. The laminating is therefore the rate-determining step, and thus limits the productivity of the line for producing the adhesive tape.

Second, it is disadvantageous in certain cases if the liner material passes through the drying apparatus. The temperature prevailing in the drying unit may result in unwanted alteration or destruction of the liner material. For example, drying may result in the liner material drying out. For this reason, in the method described, only certain liner materials can be used, while other liner materials, which on the basis of their properties in the context, for example, of adhesive tapes are desirable, cannot be used. The existing method therefore limits the number of possible liner materials to those which are not deleteriously altered by the coating and drying step.

DE 101 47 036 A1 discloses a method for delaminating and laminating webs. This method uses dehesively treated carrier materials, which are laminated and delaminated, the lamination of the adhesive layer onto the dehesively treated carrier material and the delamination of the carrier material being performed without an interruption to the method.

It is an object of the invention to eliminate the drawbacks inherent in the prior art. The intention more particularly is to specify a method for producing a tapelike laminate where the rate of lamination does not determine the rate of the coating of an adhesive onto a tapelike carrier material and the drying of the laminated adhesive layer. An additional intention is to specify apparatus for carrying out the method, and uses of the apparatus.

This object is achieved by the features of the invention as described hereinbelow.

Provided in accordance with the invention is a method for producing a tapelike laminate which comprises a tapelike carrier material and, on at least one of the surfaces of the tapelike carrier material, a first adhesive layer. The method comprises the following steps:
(a) coating a first tapelike auxiliary carrier material with at least one first adhesive layer, and winding the coated first auxiliary carrier material onto a first roll;
(b) unwinding the coated first tapelike auxiliary carrier material from the first roll, and guiding the coated first tapelike auxiliary carrier material to a first laminating roller;
(c) laminating the coated first tapelike auxiliary carrier material onto the tapelike carrier material, so that the first adhesive layer is facing the tapelike carrier; and
(d) delaminating the first auxiliary carrier material from the first adhesive layer.

The method of the invention separates the coating of the carrier material with the adhesive layer and its drying on the carrier layer from the lamination.

Accordingly, step (a), i.e., the coating and drying operation, on the one hand, and steps (b) to (d), i.e., the laminating operation, on the other, are performed separately from one another. With a first unit, therefore, the first adhesive layer can be laminated onto an auxiliary carrier material and then dried. The auxiliary carrier material thus coated is then wound onto a roll. The production of the coated auxiliary carrier material can therefore take place completely independently of the rate at which lamination occurs in steps (b) to (d). Through the separation of these two operations, a considerable gain in speed in the production of tapelike laminates is achieved. This achievement can be attributed to fewer holding points, due for example to the running lengths of the individual materials or to frequent bale changeovers. Furthermore, each operation can be halted and started up again as desired, independently of the other. In addition, the two operations can be separated from one another in terms both of location and of time.

Furthermore, the method of the invention avoids possible faults in the carrier material and thereby saves on costs. If a fault occurs during laminate production in the coating and drying operation and if, accordingly, the production apparatus has to be stopped, faults are formed in the as yet unfinished tapelike laminate, and have to be cut out. Accordingly, with conventional methods, sections—in some cases large—with carrier material have to be cut out and disposed of, since this material is employed in the actual coating and drying operation. With the method of the invention, in contrast, only the substantially less costly auxiliary carrier material has to be cut away.

Furthermore, the auxiliary carrier material generally has substantially longer running lengths than the carrier material, and so, with the method of the invention, in comparison to the prior art, the individual tape sections in the coating and drying operation are substantially longer, and, therefore, the production apparatus has to be stopped less often for the purpose of renewing the tape material. This increases the efficiency of the method.

The auxiliary carrier material, also referred to as in-process liner, can be re-used. This allows considerable cost savings. Since the auxiliary carrier material is not part of the end product, the carrier material which is used in the end product can be selected independently of whether it is adversely altered by the coating and subsequent drying in the coating and drying operation. In particular, drying-out of the carrier material, and the possible need for it to be re-wetted, are avoided. In the coating and drying operation, the prevailing temperatures, for example, are from 40° to 180° C., while the laminating operation can be performed at room temperature, for example. In the methods known from the prior art, in contrast to the present invention, the carrier material is exposed to the higher temperatures from the coating and drying operation, and so the requirements on the temperature stability of the carrier material are much higher. Furthermore, in the coating and drying operation, the material is subject to irradiation (e.g., EBC irradiation) and to higher mechanical loads than in the laminating operation. Consequently, in accordance with the present invention, the carrier material used can be a material which is not so resistant to radiation and to pressure as the auxiliary carrier material is. In contrast to the coating and drying operation, the laminating operation does not expose the material to any chemical changes. Overall, therefore, the carrier material can be less robust than is necessarily the case with the prior-art method.

The method of the invention can be used to produce, for example, single-sided and double-sided adhesive tapes.

The auxiliary carrier material coated with the adhesive is referred to here as the coated auxiliary carrier material. The auxiliary carrier material preferably has a nonstick coating on both sides, thereby facilitating the transfer of the adhesive layer to the tapelike carrier material.

The term “laying-on” means the laying of a material onto a roller. Where the roller already carries a first material, the laying-on of a second material laminates said second material onto the first material.

In one embodiment of the invention, the method further comprises the steps of
(e) coating a second tapelike auxiliary carrier material with at least one second adhesive layer, and winding the coated second auxiliary carrier material onto a second roll;
(f) unwinding the coated second tapelike auxiliary carrier material from the second roll, and guiding the coated second tapelike auxiliary carrier material to the first laminating roller or to a second laminating roller;
(g) laminating the coated second tapelike auxiliary carrier material onto the tapelike carrier material, so that the second adhesive layer is facing the tapelike carrier material; and
(h) delaminating the second auxiliary carrier material from the second adhesive layer.

By means of this embodiment of the invention it is possible to produce a double-sided adhesive tape.

Steps (a) and (e), which both belong to the coating and drying operation, can be performed independently of one another before steps (b) to (f). Steps (c), (d), (g) and (f) may be performed on one laminating roller or two laminating rollers.

Advantageously, a tapelike liner material may be laminated onto the first adhesive layer subsequently to step (d). This lamination may take place, for example, on the first laminating roller.

In a likewise preferred embodiment of the invention, especially for producing a double-sided adhesive tape,
by means of a first lay-on roller, the tapelike carrier material is laid onto the first laminating roller, and the coated first auxiliary carrier material is laid onto the tapelike carrier material, with the first adhesive layer facing the carrier material;
by means of a first delaminating device following in web direction, the first auxiliary carrier material is delaminated from the first adhesive layer;
by means of a second lay-on roller following in web direction, the liner material is laminated onto the first adhesive layer;
the tapelike carrier material, which is laminated on one surface with the adhesive layer and thereupon with the liner material, is taken from the first laminating roller and laid onto a second laminating roller, with the liner material facing the second laminating roller; and
by means of a third lay-on roller following in web direction, the coated second auxiliary carrier material is laid onto the tapelike carrier material, with the second adhesive layer facing the carrier material; and
by means of a second delaminating device following in web direction, the second auxiliary carrier material is delaminated from the second adhesive layer.

Alternatively, in a further preferred embodiment, a double-sided adhesive tape can be produced as follows:
by means of a first lay-on roller, the coated first auxiliary carrier material is laid onto the first laminating roller, so that the adhesive layer faces away from the laminating roller, and the tapelike carrier material is laid onto the first adhesive layer;
by means of a second lay-on roller following in web direction, the coated second auxiliary carrier material is laid onto the tapelike carrier material, with the second adhesive layer facing the carrier material;
by means of a first delaminating device following in web direction, the second auxiliary carrier material is delaminated from the second adhesive layer;
by means of a third lay-on roller following in web direction, the liner material is laminated onto the second adhesive layer;
by means of a second delaminating device following in web direction, the first auxiliary carrier material is delaminated from the first adhesive layer.

In a further preferred embodiment of the invention for producing a double-sided adhesive tape,
the coated first auxiliary carrier material and the tapelike carrier material are laminated between a first roller pair, so that the first adhesive layer is disposed between the first auxiliary carrier material and the tapelike carrier material;
by means of a second roller pair following in web direction, the coated second auxiliary carrier material is laminated onto the uncoated surface of the tapelike carrier material, the second adhesive layer being disposed between the second auxiliary carrier material and the tapelike carrier material;
one of the two auxiliary carrier materials is delaminated by means of a first delaminating device following in web direction;
the liner material is laminated onto the exposed first or second adhesive layer by means of a third roller pair following in web direction; and
the remaining auxiliary carrier material is delaminated by means of a second delaminating device following in web direction.

It is possible, furthermore, to subdivide the laminating operation into two method sections, in order to simplify the method conditions. In this case the following is possible:
in a first method section, a laminate precursor with the layer sequence first auxiliary carrier material/first adhesive layer/tapelike carrier material/second adhesive layer is produced, and the laminate precursor is wound onto a roller; and
in a second method step, the laminate precursor is unwound from the roller, and the liner material is laminated onto the second adhesive layer to give the laminate end product.

Alternatively, the following is possible:
in a first method section, a laminate precursor with the layer sequence tapelike carrier material/second adhesive layer/liner material is produced, and the laminate precursor is wound onto a roller; and
in a second method step, the laminate precursor is unwound from the roller, and the coated first auxiliary carrier material is laminated onto the uncoded surface of the tapelike carrier material, and the first auxiliary carrier material is delaminated in a delaminating device following in web direction, to give the laminate end product.

The tapelike carrier material is preferably subjected to a corona treatment prior to its lamination. The first adhesive layer and the second adhesive layer may be identical or different. Likewise, the first auxiliary carrier material and the second auxiliary carrier material may be identical or different.

Further provided in accordance with the invention is apparatus for producing a tapelike laminate. The apparatus comprises an accommodating device for the first roll, from which the coated first auxiliary carrier material is unwound; a laminating roller; a lay-on roller for laying the tapelike carrier material and the coated first auxiliary carrier material onto the laminating roller; and a first delaminating device for delaminating the first auxiliary carrier material from the first adhesive layer.

Where a double-sided adhesive tape is to be produced, the apparatus advantageously further comprises an accommodating device for the second roll, from which the coated second auxiliary carrier material is unwound; a lay-on roller for laying-on the coated second auxiliary carrier material; and a second delaminating device for delaminating the second auxiliary carrier material from the second adhesive layer.

Irrespective of whether a single-sided or double-sided adhesive tape is to be produced, there ought to be a lay-on roller for laying-on the liner material.

The delaminating devices may be a roller, more particularly having radii in the range from 5 mm to 100 mm and more preferably in the range from 10 mm to 50 mm, or a rounded wedge, in particular with rounding radii of 1 mm up to a radius equal to that of the roller, and more preferably with radii of 5 mm to 30 mm.

The lay-on rollers are in contact with the laminating roller, specifically in such a way that the axes of the rollers are disposed in parallel, with the disposition of the lay-on rollers being limited by the disposition of the other rollers, those in contact with the laminating roller. Nip adjustment between a lay-on roller and the laminating roller ought to be variable, and lamination can take place with linear pressures of 0 N/mm to 50 N/mm, more preferably with linear pressures of 2 N/mm to 10 N/mm.

Roller pairs provided in accordance with the invention consist of two mutually opposing rollers, in which case nip adjustment ought to be variable, and lamination can take place with linear pressures of 0 to 50 N/mm, more preferably with linear pressures of 2 to 10 N/mm.

All rollers can be cooled or heated in a preferred range from −40° C. to 200° C. with oil, water, steam, electrically, or with other temperature-conditioning media; furthermore, the roller surfaces are of steel, stainless steel, chromium-plated steel, dehesively treated steel or stainless steel, or elastic or elastically dehesively treated material having a Shore hardness (A) of 20 to 100, more particularly having a Shore hardness (A) of 60 to 80. The elastic roller covering may be composed preferably of EPDM, VITON, silicone rubber or dehesively treated EPDM, VITON or silicone rubber.

Examples of tapelike carrier material that can be used include nonwovens, papers, oriented PP, HDPE, LDPE, PVC, and PET films, and foams (e.g., PE foams or PVA foams) and woven fabrics, this recitation not being exhaustive. The carrier material is preferably of tear-sensitive and stretch-sensitive design.

As auxiliary carrier material it is preferred to use carrier materials with a nonstick coating on one or both sides, examples being paper, especially coated paper, such as PE paper, and oriented PP, HDPE, LDPE, PVC, MOPP, BOPP, PEN, PMP, PA, and PET films. Particular preference is given to silicone-coated carrier materials and also to carrier materials having silicone-free release layers such as paraffin, Teflon or waxes, for example. Composite materials, such as PET/aluminum sheet, can also be used. The auxiliary carrier material is advantageously designed to have wet strength.

Where the tapelike carrier material, the first auxiliary carrier material and/or the second auxiliary carrier material are composed of paper, the paper preferably has a basis weight of 40 g/m² to 200 g/m².

Where the first auxiliary carrier material and/or the second auxiliary carrier material are composed of oriented polypropylene (PP), the latter has a thickness preferably of 40 to 200 μm, preferably 75 to 125 μm. Where the auxiliary carrier materials are composed of polyester carrier webs (PET), they preferably have a thickness of 20 to 200 μm, more preferably 40 to 80 μm. The carrier material, in contrast, may preferably be given a thinner design, with a thickness, for example, of 5 to 50 μm, more particularly 6 to 15 μm. This is made possible by the fact that the carrier material is not exposed to any chemical alterations and is exposed to lower mechanical loads than the auxiliary carrier material.

Preference is given to using double-sidedly and single-sidedly silicone-coated auxiliary carrier materials having release forces, measured in accordance with BDF Test Method JOPMH003, test tape tesa 7475, of between 1 to 60 cN/cm, test tape tesa 7476, between 3 to 100 cN/cm, more preferably with release forces of less than 20 cN/cm, test tape tesa 7475, and less than 30 cN/cm, test tape tesa 7476.

Liner material used may be, for example, siliconized paper, film, e.g., MOPP, PET or PE film, or coated paper.

As adhesive for producing the adhesive layer, it is possible to use not only adhesives based on solvent-containing natural rubber adhesives and acrylate adhesives, but also solvent-free adhesives. An example of solvent-containing adhesives are adhesives based on styrene-isoprene-styrene block copolymers.

The amount of adhesive applied to the carrier material is preferably 15 to 150 g/m². In a further preferred embodiment, a coatweight of 20 to 90 g/m² is set.

The coating and drying operation may take place in accordance with known methods. An overview of typical production methods is found, for example, in “Coating Equipment”, Donatas Satas, in Handbook of Pressure Sensitive Adhesives Technology, second edition, edited by Donatas Satas, Van Nostrand Reinhold New York pp. 767-808. The known methods for drying and slitting the adhesive tapes can likewise be found in the Handbook of Pressure Sensitive Adhesive Technology, pages 809-874.

A suitable adhesives is an acrylate hotmelt-based adhesive having a K value of at least 20, more particularly greater than 30 (measured in each case in 1% strength by weight solution in toluene, 25° C.), obtainable by concentrating a solution of such a composition to form a system which can be processed as a hotmelt. An adhesive of this kind is set out in DE 43 13 008 C2. In an intermediate step, the solvent is removed entirely from these acrylate compositions produced in this way.

In the acrylate hotmelt-based adhesive, benzoin derivatives may be copolymerized, examples being benzoin acrylate or benzoin methacrylate, acrylic esters or methacrylic esters. Benzoin derivatives of this kind are described in EP 0 578 151 A.

The acrylate hotmelt-based adhesive may be UV-crosslinked. Other types of crosslinking, however, are also possible, an example being electron beam crosslinking.

One particularly preferred embodiment uses, as self-adhesives, copolymers of (meth)acrylic acid and the esters thereof having 1 to 25 C atoms, maleic, fumaric and/or itaconic acid and/or their esters, substituted (meth)acrylamides, maleic anhydride, and other vinyl compounds, such as vinyl esters, more particularly vinyl acetate, vinyl alcohols and/or vinyl ethers. The residual solvent content ought to be below 1% by weight.

It is additionally possible to use an adhesive composed of the group of natural rubbers or synthetic rubbers or of any desired blend of natural rubbers and/or synthetic rubbers, it being possible in principle to select the natural rubber or rubbers from all available grades such as, for example, crepe, RSS, ADS, TSR or CV products, depending on required level of purity and of viscosity, and to select the synthetic rubber or rubbers from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA), and polyurethanes and/or blends thereof.

With further preference, thermoplastic elastomers may be added to the rubbers for the purpose of improving the processing properties, with a weight fraction of 10% to 50% by weight, based on the total elastomer fraction.

Representatives that may be mentioned at this point include in particular the especially compatible styrene-isoprene-styrene (SIS) and styrene-butadiene-styrene (SBS) types.

Tackifying resins which can be used include, without exception, all tackifier resins that are already known and are described in the literature. As representatives, mention may be made of rosins, their disproportionated, hydrogenated, polymerized, and esterified derivatives and salts, the aliphatic and aromatic hydrocarbon resins, terpene resins and terpene-phenolic resins. Any desired combinations of these and further resins may be used in order to adjust the properties of the resultant adhesive in accordance with requirements. Reference may be made expressly to the depiction of the state of the art in “Handbook of Pressure Sensitive Adhesive Technologies” by Donatas Satas (von Nostrand, 1989).

### BRIEF DESCRIPTION OF DRAWINGS

The invention is illustrated below with reference to embodiments, referring to the drawings. In those drawings

FIG. 1 shows a diagrammatic representation of the coating and drying operation;

FIG. 2 shows a schematic diagram of a first embodiment of the laminating operation of the invention, using two laminating rollers;

FIG. 3 shows a schematic representation of a second embodiment of the laminating operation of the invention, using one laminating roller;

FIG. 4 shows a diagrammatic representation of a third embodiment of the laminating operation of the invention, using roller pairs;

FIG. 5 shows a diagrammatic representation of a first method section of a fourth embodiment of the laminating operation of the invention;

FIG. 6 shows a diagrammatic representation of the second method section of the fourth embodiment, shown in FIG. 5, of the laminating operation of the invention;

FIG. 7 shows a diagrammatic representation of a first method section of a fifth embodiment of the laminating operation of the invention;

FIG. 8 shows a diagrammatic representation of the second method section of the fifth embodiment, shown in FIG. 7, of the laminating operation of the invention;

FIG. 9 shows a diagrammatic representation of a first method section of a sixth embodiment of the laminating operation of the invention;

FIG. 10 shows a diagrammatic representation of the second method step of the sixth embodiment, shown in FIG. 9, of the laminating operation of the invention; and

FIG. 11 shows a diagrammatic representation of a seventh embodiment of the laminating operation of the invention.

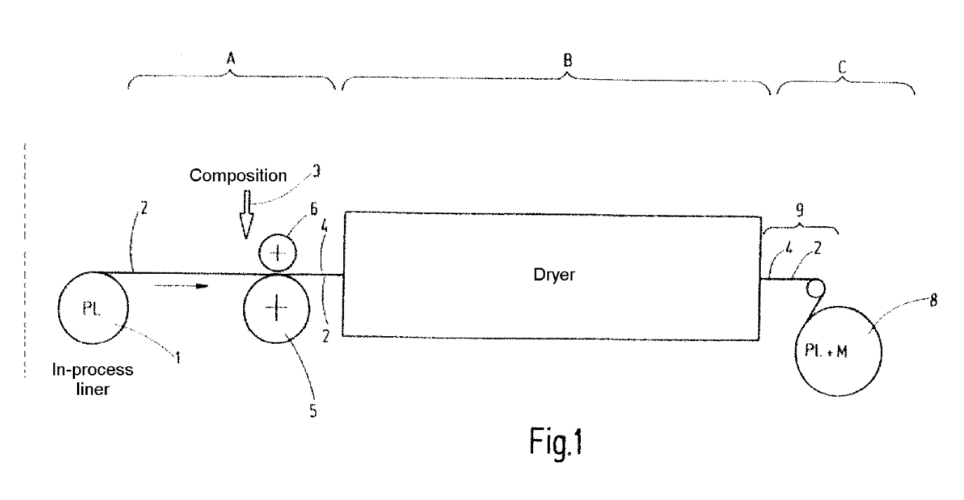

FIG. 1 shows a coating and drying operation which corresponds to steps (a) and/or (e) of the method of the invention. In section A, the first auxiliary carrier material 2 is unwound from a stock roll 1. Applied to the first auxiliary carrier material 2, subsequently, is an adhesive 3 which is laminated by means of a roller pair 5, 6, as an adhesive layer 4, onto the first auxiliary carrier material 2, thus giving the coated first auxiliary carrier material 9. In section B, the coated auxiliary carrier material is guided through a dryer 7 and lastly, in section C, is wound onto a stock roll 8 for the coated first auxiliary carrier material 9.

In principle, the production of the coated first auxiliary carrier material 9 is the same as that of the coated second auxiliary carrier material 10; the materials used, like a material of the auxiliary carrier material and the material of the adhesive layer, and also the method of conditions, may vary.

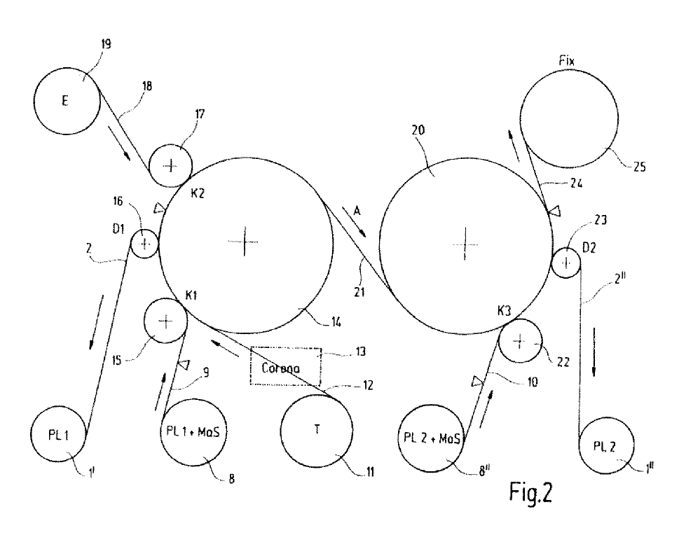

According to FIG. 2, which shows a first embodiment of the laminating step, the tapelike carrier material 12 is unwound from a stock roll 11, subjected to a corona treatment 13, and guided to the first laminating roller 14. At the same time, the coated first auxiliary carrier material 9 is unwound from a stock roll 8 and guided to the laminating roller 14. At the laminating roller 14, the tapelike carrier material and the coated first auxiliary carrier material are laid onto the first laminating roller 14 by means of the lay-on roller 15, with the tapelike carrier material 12 facing the first laminating roller 14, and the first adhesive layer 4 of the coated first auxiliary carrier material 9 facing the tapelike carrier material 12. In web direction (arrow A), the first delaminating roller 16 then follows, and is used to delaminate the auxiliary carrier material 2 from the first adhesive layer. The adhesive layer remains on the tapelike carrier material and is guided on together with it, while the delaminated first auxiliary carrier material 2 is wound onto a further stock roll 1′ and can be supplied again to the coating and drying operation (FIG. 1).

The tapelike carrier material 12 coated with the first adhesive layer is guided, on the first laminating roller, to a second lay-on roller 17. By means of this lay-on roller 17, the liner material 18, which is unwound from a stock roll 19, is laminated onto the first adhesive layer.

The resulting laminate precursor 21, which has the layer construction tapelike carrier material/first adhesive layer/liner material, is then guided from the first laminating roller 14 to the second laminating roller 20, the liner material 18 now facing the second laminating roller. The second laminating roller 20 and the first laminating roller 14 are disposed in parallel to one another at the same height.

Following the second laminating roller 20 now, in web direction, is the third lay-on roller 22, which laminates the coded second auxiliary carrier material 10 onto that surface of the tapelike carrier material that does not bear the first adhesive layer. The second adhesive layer of the coated second auxiliary carrier material is facing the tapelike carrier material 12. The coated second auxiliary carrier material 10 is unwound from a stock roll 8″. There then follows, in web direction, the second delaminating roller 23, which delaminates the auxiliary carrier material 2″ from the second adhesive layer. The second adhesive layer remains on the tapelike carrier material and is guided on together with it, while the delaminated second auxiliary carrier material 2″ is wound up onto a further stock roll 1″ and can be supplied again to the coating and drying operation (FIG. 1). The laminate remaining on the second laminating roller has the construction liner material/first adhesive layer/tapelike carrier material/second adhesive layer, and constitutes the completed tapelike laminate, i.e., the laminate end product 24, which is wound up onto a stock roll 25.

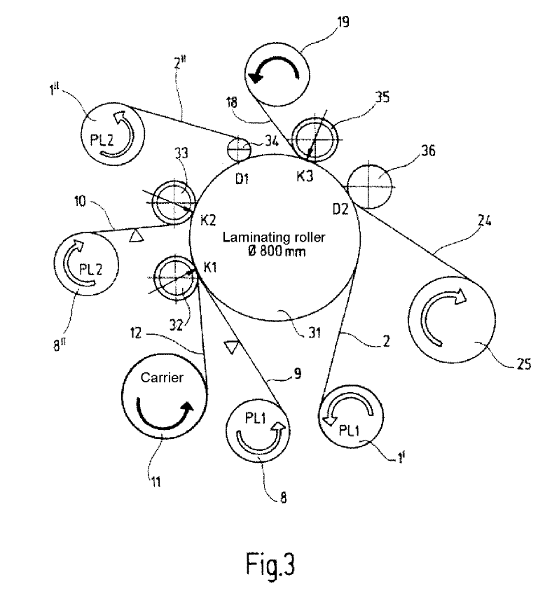

FIG. 3 shows a second embodiment of the laminating step of the invention, where only one laminating roller 31 is used. According to this embodiment, the coated first auxiliary carrier material 9 is unwound from a stock roll 8 and guided to the laminating roller 31. At the same time, the tapelike carrier material 12 is unwound from a stock roll 11 and guided to the laminating roller 31. At the laminating roller 31, the tapelike carrier material 12 and the coated first auxiliary carrier material 9 are laid onto the laminating roller 31 by means of the first lay-on roller 32, with the coated first auxiliary carrier material 9 facing the laminating roller 31, and the first adhesive layer facing away from the laminating roller 31, and the tapelike carrier material 12 lying on the first adhesive layer 4.

Following in web direction is the second lay-on roller 33, which laminates the coated second auxiliary carrier material 10 onto that surface of the tapelike carrier material 12 that does not bear the first adhesive layer. Here, the second adhesive layer of the coated second auxiliary carrier material 10 is facing the tapelike carrier material 12. The coated second auxiliary carrier material 10 is unwound from a stock roll 8″. There follows in web direction the first delaminating roller 23, which delaminates the auxiliary carrier material 2″ from the second adhesive layer. The second adhesive layer remains on the tapelike carrier material 12 and is guided on together with it, while the delaminated second auxiliary carrier material 2″ is wound onto a further stock roll 1″ and can be supplied again to the coating and drying operation (FIG. 1).

The laminate precursor, with the construction first auxiliary carrier material/first adhesive layer/tapelike carrier material/second adhesive layer/liner material, is guided on the laminating roller 31 to a third lay-on roller 35. By means of this lay-on roller 35, the liner material 18, which is unwound from a stock roll 19, is laminated onto the second adhesive layer.

Following in web direction is the second delaminating roller 36, which delaminates the auxiliary carrier material 2 from the first adhesive layer. The adhesive layer remains on the tapelike carrier material 12 and is guided on together with it, while the delaminated first auxiliary carrier material 2 is wound up on a further stock roll 1′ and can be supplied again to the coating and drying operation (FIG. 1).

The resulting laminate 21 has the construction first adhesive layer/tapelike carrier material/second adhesive layer/liner material, and constitutes the completed tapelike laminate, i.e., the laminate end product 24, which is wound onto a stock roll 25.

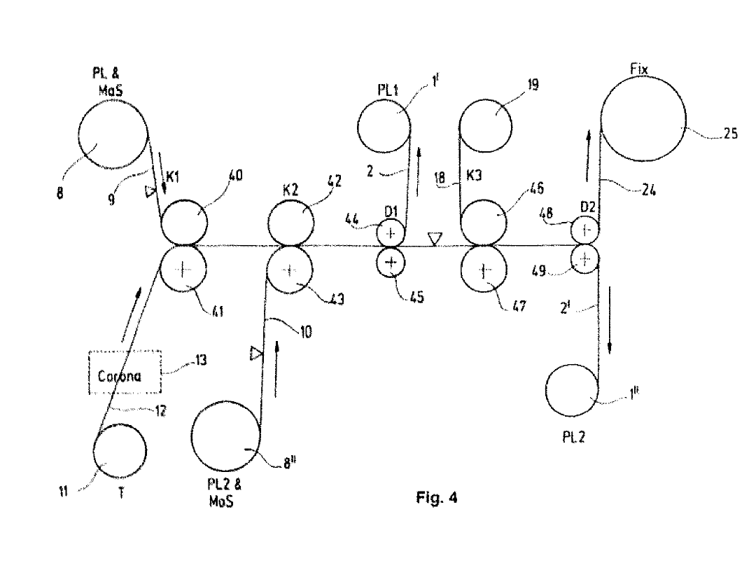

FIG. 4 shows a third embodiment of the laminating operation of the invention. In this embodiment, the tapelike carrier material 12, which is unwound from its stock roll 11, is first subjected to a corona treatment and then laminated together with the coated first auxiliary carrier material 9 between a first roller pair 40, 41, and so the first adhesive layer is disposed between the first auxiliary carrier material 2 and the tapelike carrier material 1. Subsequently, the coated second auxiliary carrier material 10 is laminated onto the uncoated side of the tapelike carrier material 1 by means of a second roller pair 42, 43 which follows in web direction, the second adhesive layer being disposed between the second auxiliary carrier material 2″ and the tapelike carrier material 1.

There follows in web direction a first delaminating device, consisting of a roller pair 44, 45, which is used to delaminate the first auxiliary carrier material 2 from the first pressure-sensitive adhesive. This is followed by a third roller pair 46, 47, which laminates the liner material 18 onto the first adhesive layer. At the last roller pair 48, 49 in web direction, i.e., at the second delaminating device, the remaining second auxiliary carrier material 2″ is delaminated. The resulting laminate has the construction liner material/first adhesive layer/tapelike carrier material/second adhesive layer, and constitutes the completed tapelike laminate, i.e., the laminate end product 24, which is wound up onto a stock roll 25.

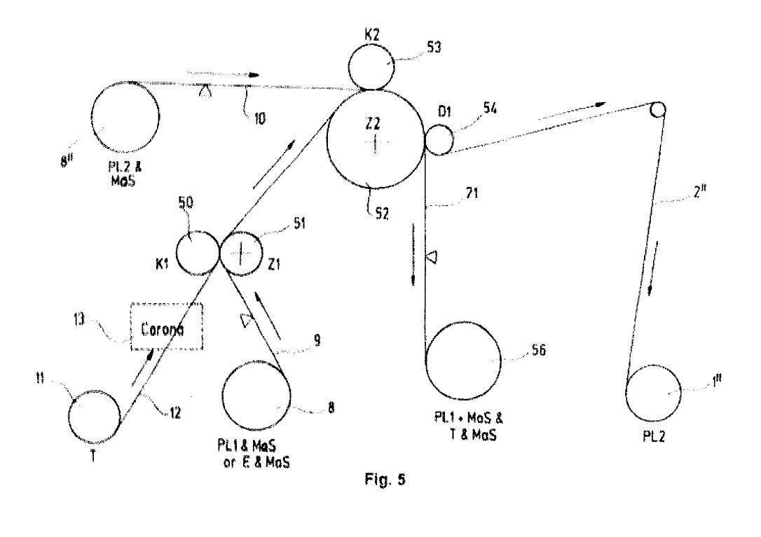

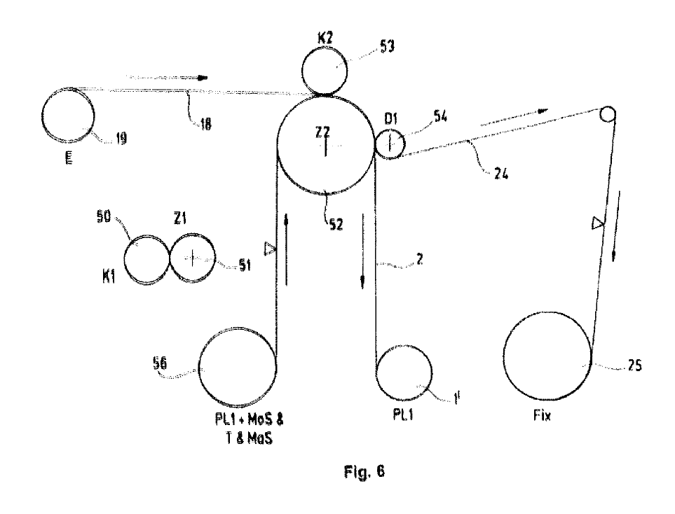

FIGS. 5 and 6 show a fourth embodiment of the laminating operation of the invention, comprising two separate method sections. In FIG. 5, which shows the first method section, a roller pair 50, 51 laminates the tapelike carrier material 12, which is subjected to a corona treatment 13, onto the coated first auxiliary carrier material 9, specifically in such a way that the first adhesive layer is facing the tapelike carrier material 12. Alternatively, in the upstream coating and drying operation, the adhesive layer can also be applied directly to the liner material (E & MaS), the liner material in that case being supplied instead of the auxiliary carrier material to the roller pair 50, 51. In this alternative embodiment, therefore, the liner material takes over the function of the auxiliary carrier material. Consequently there is no need for a separate auxiliary carrier material.

The resulting laminate precursor, with the layer construction tapelike carrier material/first adhesive layer/first auxiliary carrier material, is then supplied to a laminating roller 52, where a lay-on roller 53 laminates the coated second auxiliary carrier material 10 onto that surface of the tapelike carrier material 1 that does not bear the first adhesive layer, specifically in such a way that the second adhesive layer is facing the tapelike carrier material 12. Following the laminating roller 52 in web direction is a first delaminating roller 54, which delaminates the second auxiliary carrier material from the second adhesive layer. The remaining laminate precursor 55 has the construction first auxiliary carrier material/first adhesive layer/tapelike carrier material/second adhesive layer, and is wound up onto a stock roll 56.

In the second method section, which is shown in FIG. 6, the laminating roller 52, the lay-on roller 53, and the delaminating roller 56 are utilized in order to laminate the liner material 18 onto the second adhesive layer. For this purpose, instead of the stock roll 8 used in the first method section, the stock roll 56 is loaded with the laminate precursor 55. From there, the laminate precursor 55 is guided to the laminating roller 52. The lay-on roller 53 laminates the liner material 18, which is supplied from the stock roll 19, which has been loaded instead of the stock roll 8″ for the second coated auxiliary carrier material 10, onto the second adhesive layer. At the subsequent delaminating roller 54, the first auxiliary carrier material 2 is delaminated and wound up on the stock roll 1′. The stock roll 1′ takes the place of the stock roll for the laminate precursor. The resulting laminate has the construction first adhesive layer/tapelike carrier material/second adhesive layer/liner material, and constitutes the completed tapelike laminate, i.e., the laminate end product 24, which is wound onto a stock roll 25.

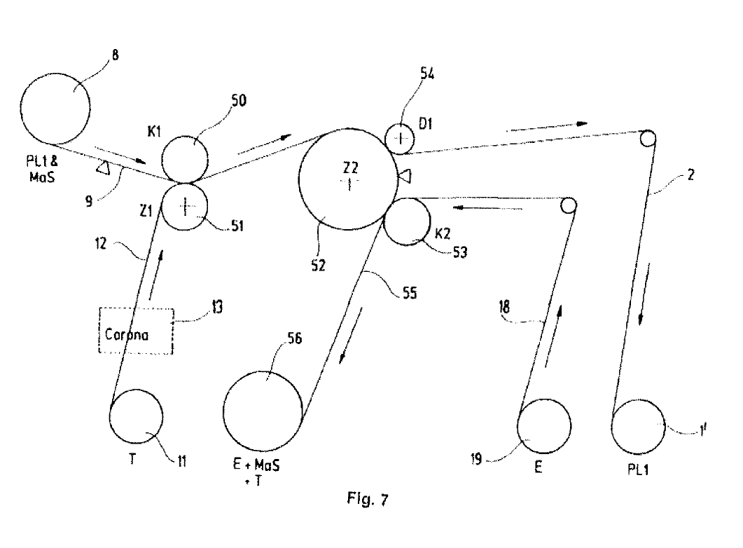

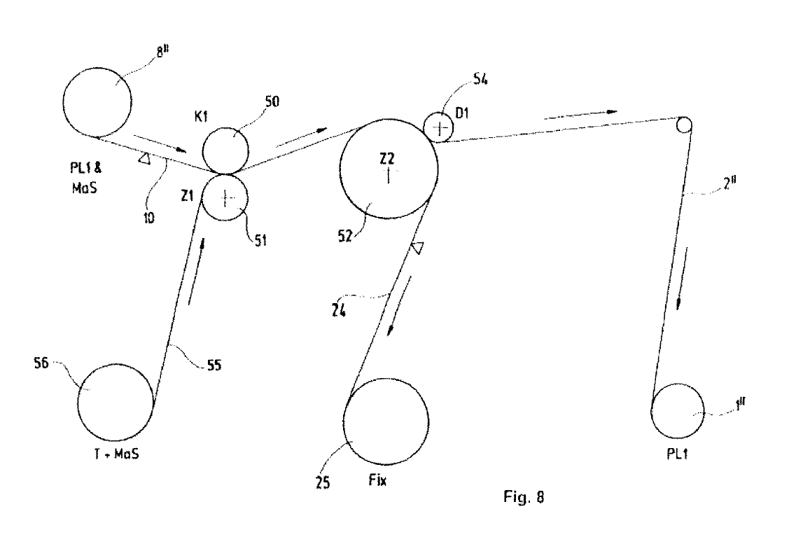

FIGS. 7 and 8 show a fifth embodiment of the laminating operation of the invention, comprising two separate method sections. In FIG. 7, which shows the first method section, a roller pair 50, 51 laminates the tapelike carrier material 12, which is subjected to a corona treatment 13, onto the coated first auxiliary carrier material 9, specifically in such a way that the first adhesive layer is facing the tapelike carrier material 12. The resulting laminate precursor, with the layer construction tapelike carrier material/first adhesive layer/first auxiliary carrier material, is then supplied to a laminating roller 52, where, by means of a delaminating roller 54, the first auxiliary carrier material is delaminated from the first adhesive layer. This is followed at the laminating roller 52 by a lay-on roller 53, which laminates the liner material 18 onto that surface of the tapelike carrier material 1 that bears the first adhesive layer. The laminate precursor 55 obtained has the construction liner material/first adhesive layer/tapelike carrier material, and is wound onto a stock roll 56.

In the second method section, shown in FIG. 8, the laminating roller 52, the lay-on roller 53, and the delaminating roller 56 are utilized in order to laminate the coated second auxiliary carrier material 10 onto that surface of the tapelike carrier material 12 that does not bear the first adhesive layer. In the case shown, the coated first auxiliary carrier material and the coated second auxiliary carrier material have the same construction and the same composition.

For this purpose, instead of the stock roll 11 used in the first method section, the stock roll 56 is charged with the laminate precursor 55. The roller pair 50, 51 laminates the coated second auxiliary carrier material (which in this case is the same as the coated first auxiliary carrier material 9) onto the laminate precursor 55, specifically in such a way that the second adhesive layer is facing the tapelike carrier material 12. The coated second auxiliary carrier material 10 is unwound from a stock roll 8″, which has been loaded in place of the stock roll 8. Since, in this case, the coated second auxiliary carrier material 10 is the same as the coated first auxiliary carrier material 9, however, there is no need for the stock rolls to be replaced.

The resulting laminate precursor, with the layer construction second auxiliary carrier material/second adhesive layer/tapelike carrier material/first adhesive layer/liner material, is then supplied to the laminating roller 52, where, by means of the delaminating roller 54, the second auxiliary carrier material 2″ is delaminated from the second adhesive layer and wound onto the stock roll 1″, which has been loaded in place of the stock roll 1′, although in this case there is no need for this on account of the two coated auxiliary carrier materials being the same. The laminate obtained has the construction first adhesive layer/tapelike carrier material/second adhesive layer/liner material, and constitutes the completed tapelike laminate, i.e., the laminate end product 24, which is wound onto a stock roll 25.

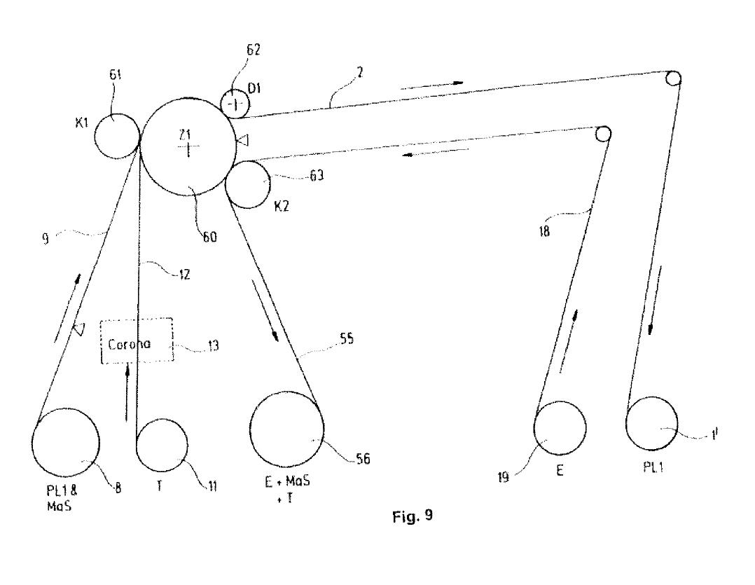

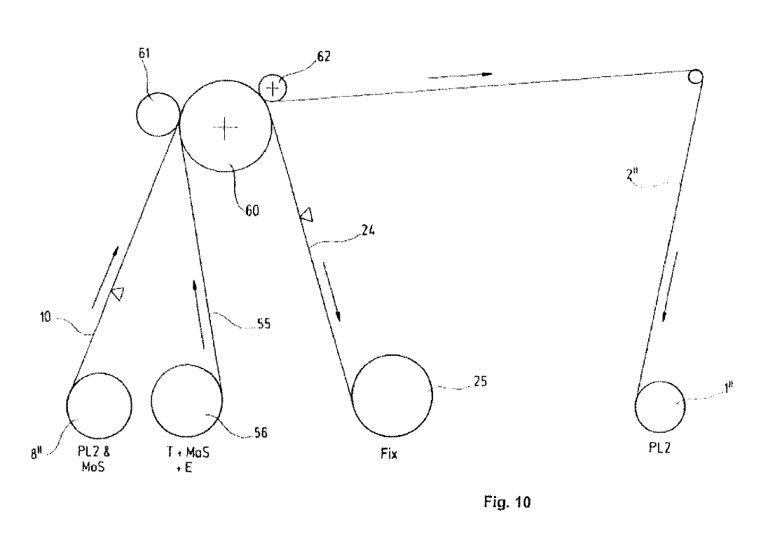

FIGS. 9 and 10, which depict a further embodiment of the laminating operation, likewise depict two method sections. In the first method section, which is shown in FIG. 9, the tapelike carrier material 12, which is subjected to a corona treatment 13, and the coated first auxiliary carrier material 9 are laid by means of a lay-on roller 61 onto the laminating roller 60, specifically in such a way that the tapelike carrier material 12 is facing the laminating roller 60 and the first adhesive layer is facing the tapelike carrier material 12. The delaminating roller 62 then follows the laminating roller 60, and is used to delaminate the first auxiliary carrier material 2 from the first adhesive layer. The laminating roller 57 is then followed by a second lay-on roller 63, which laminates the liner material 18 onto the first adhesive layer. The laminate precursor 55 obtained has the construction liner material/first adhesive layer/tapelike carrier material, and is wound onto a stock roll 56.

In the second method section, which is shown in FIG. 10, the laminating roller 60, the first lay-on roller 61, and the delaminating roller 62 are utilized in order to laminate the coated second auxiliary carrier material 10 onto that surface of the tapelike carrier material 12 that does not bear the first adhesive layer. For this purpose, instead of the stock roll 11 used in the first method section, the stock roll 56 is loaded with the laminate precursor 55. From there, the laminate precursor 55 is guided to the laminating roller 60. By means of the lay-on roller 61, the coated second auxiliary carrier material 10, which is supplied from the stock roll 8′, was loaded in place of the stock roll 8 for the coated first auxiliary carrier material 9, and is laminated onto that surface of the tapelike carrier material 12 that does not bear the first adhesive layer. At the subsequent delaminating roller 62, the first auxiliary carrier material 2 is delaminated and wound onto the stock roll 1″. The stock roll 1″ here is loaded in place of the stock roll 1′. The laminate obtained has the construction liner material/first adhesive layer/tapelike carrier material/second adhesive layer, and constitutes the completed tapelike laminate, i.e., the laminate end product 24, which is wound onto a stock roll 25.

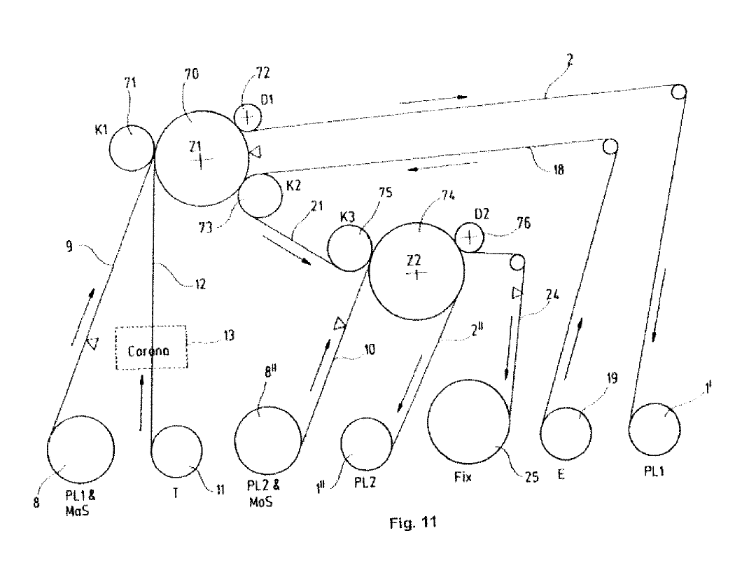

FIG. 11, which shows a seventh embodiment of the invention, comprises only one method section. In this case, the tapelike carrier material 12 is unwound from a stock roll 11, subjected to a corona treatment 13, and guided to the first laminating roller 70. At the same time, the coated first auxiliary carrier material is unwound from a stock roll 8 and guided to the laminating roller 70. At the laminating roller 70, the tapelike carrier material 12 and the coated first auxiliary carrier material 9 are laid by means of the first lay-on roller 71 onto the first laminating roller 70, with the tapelike carrier material 12 facing the first laminating roller 70, and the first adhesive layer of the coated first auxiliary carrier material 9 facing the tapelike carrier material 12. Following in web direction, then, is the first delaminating roller 72, which delaminates the first auxiliary carrier material 2 from the first adhesive layer. The first adhesive layer remains on the tapelike carrier material and is guided on together with it, while the delaminated first auxiliary carrier material 2 is wound up onto a further stock roll 1′ and can be supplied again to the coating and drying operation (FIG. 1).

The tapelike carrier material 12 coated with the first adhesive layer is guided on the first laminating roller 70 to a second lay-on roller 73. This lay-on roller 73 laminates the liner material 18, which is unwound from a stock roll 19, onto the first adhesive layer.

The resulting laminate precursor 21, which has the layer construction tapelike carrier material/first adhesive layer/liner material, is then guided from the first laminating roller 70 to the second laminating roller 74. There, the laminate precursor 21 is made by means of a third lay-on roller 75 onto the coated second auxiliary carrier material 10, which is supplied simultaneously to the third lay-on roller 75; the coated second auxiliary carrier material 10 is facing the second laminating roller 74, and the second adhesive layer is facing away from the second laminating roller 74 and is facing the tapelike carrier material 12 of the laminate precursor 21. The second laminating roller 74 and the first laminating roller 70 are disposed parallel to one another but at different heights—specifically, laminating roller 70 above laminating roller 74.

The second laminating roller 20 is then followed in web direction by the second delaminating roller 76, which delaminates the auxiliary carrier material 2″ from the second adhesive layer. The second adhesive layer remains on the tapelike carrier material 12 and is guided on together with it, while the delaminated second auxiliary carrier material 2″ is wound onto a further stock roll 1″ and can be supplied again to the coating and drying operation (FIG. 1). The laminate remaining on the second laminating roller has the construction liner material/first adhesive layer/tapelike carrier material/second adhesive layer, and constitutes the completed tapelike laminate, i.e., the laminate end product 24, which is wound onto a stock roll 25.

### EXAMPLE 1

### Production of a Double-Sided Adhesive Tape in Accordance with the Embodiment Shown in FIG. 4

The double-sided adhesive tape is produced starting from a PET film carrier material 12 μm thick. For effective adhesive anchorage, the PET film is first corona-pretreated on both sides. Then a roller pair laminates a first auxiliary carrier material onto the carrier material. The auxiliary carrier material used is a double-sidedly siliconized MOPP film in a thickness of 100 μm, which has been coated on one side with an adhesive in a thickness of 100 g/m². In a further step, a second auxiliary carrier material, which is identical to the first auxiliary carrier material, is laminated onto the other side of the carrier material. Thereafter, using a further roller pair, the first auxiliary carrier material is delaminated from the first pressure-sensitive adhesive, and then a liner material is laminated onto the delaminated side. For the liner material, a siliconized MOPP film in 80 μm thickness is used. In a last step, then, a further roller pair delaminates the second auxiliary carrier material, and at the same time the laminate obtained (double-sided adhesive tape) is wound onto a stock roll.

### LIST OF REFERENCE SYMBOLS

1 Stock roll for auxiliary carrier material 2

2 First auxiliary carrier material

2″ Second auxiliary carrier material

3 Adhesive

4 Adhesive layer

5, 6 Roller pair

7 Dryer

8 Stock roll for the coated first auxiliary carrier material 9

8″ Stock roll for the coated second auxiliary carrier material 10

9 Coated first auxiliary carrier material

10 Coated second auxiliary carrier material

11 Stock roll for the tapelike carrier material

12 Tapelike carrier material

13 Corona treatment

14 First laminating roller

15 First lay-on roller

16 First delaminating roller

17 Second lay-on roller

18 Liner material

19 Stock roll for the liner material

20 Second laminating roller

21 Laminate precursor

22 Third lay-on roller

23 Second delaminating roller

24 Laminate end product

25 Stock roll for the laminate end product

31 Laminating roller

32 First lay-on roller

33 Second lay-on roller

34 First delaminating roller

35 Third lay-on roller

36 Second delaminating roller

40, 41 First roller pair

42, 43 Second roller pair

44, 45 First delaminating device

46, 47 Third roller pair

48, 49 Second delaminating device

50, 51 Roller pair

52 Laminating roller

53 Lay-on roller

54 Delaminating roller

55 Laminate precursor

56 Stock roll for the laminate precursor

60 Laminating roller

61 First lay-on roller

62 Delaminating roller

63 Second lay-on roller

70 First laminating roller

71 First lay-on roller

72 First delaminating roller

73 Second lay-on roller

74 Second laminating roller

75 Third lay-on roller

76 Second delaminating roller

T Tapelike carrier material 1

PL Auxiliary carrier material 2, 2″ (=in-process liner)

PL1 First auxiliary carrier material 2 (=in-process liner without adhesive layer)

PL1+MaS Coated first auxiliary carrier material 9 (=in-process liner coated with first adhesive layer)

PL2 Second auxiliary carrier material 2″ (=in-process liner without adhesive layer)

PL2+MaS Coated second auxiliary carrier material 20 (=in-process liner coated with second adhesive layer)

E Liner material 18 (=end-customer liner)

tesa Tapelike laminate (=laminate end product)

K Laminating point (K1=laminating point 1, K2=laminating point 2, etc.)

D Delaminating point (D1=delaminating point 1, D2=delaminating point 2, etc.)

1. A method for producing a tapelike laminate that comprises a tapelike carrier material and, on at least one of the surfaces of the tapelike carrier material, a first adhesive layer, said method comprising the steps of:
(a) coating a first tapelike auxiliary carrier material with at least the first adhesive layer, and winding the coated first auxiliary carrier material onto a first roll;
(b) unwinding the coated first tapelike auxiliary carrier material from the first roll, and guiding the coated first tapelike auxiliary carrier material to a first laminating roller;
(c) laminating the coated first tapelike auxiliary carrier material onto the tapelike carrier material, so that the first adhesive layer faces the tapelike carrier material; and
(d) delaminating the first auxiliary carrier material from the first adhesive layer.

2. The method of claim 1, which further comprises the steps of:
(e) coating a second tapelike auxiliary carrier material with at least one second adhesive layer, and winding the coated second auxiliary carrier material onto a second roll;
(f) unwinding the coated second tapelike auxiliary carrier material from the second roll, and guiding the coated second tapelike auxiliary carrier material to the first laminating roller or to a second laminating roller;
(g) laminating the coated second tapelike auxiliary carrier material onto the tapelike carrier material, so that the second adhesive layer faces the tapelike carrier material; and
(h) delaminating the second auxiliary carrier material from the second adhesive layer.

3. The method of claim 2, wherein steps (a) and (e) are performed, independently of one another, before steps (b) to (f).

4. The method of claim 2, wherein steps (c), (d), (g) and (f) are performed on a laminating roller or two laminating rollers.

5. The method of claim 1, wherein a tapelike liner material is laminated onto the first adhesive layer following step (d).

6. The method of claim 5, wherein the tapelike liner material is laminated onto the first adhesive layer on the first laminating roller.

7. The method of claim 2, wherein
by means of a first lay-on roller, the tapelike carrier material is laid onto the first laminating roller, and the coated first auxiliary carrier material is laid onto the tapelike carrier material, with the first adhesive layer facing the tapelike carrier material;
by means of a first delaminating device following in web a direction, the first auxiliary carrier material is delaminated from the first adhesive layer;
by means of a second lay-on roller following in the web direction, the liner material is laminated onto the first adhesive layer;
the tapelike carrier material, which is laminated on one surface with the adhesive layer and thereupon with the liner material, is taken from the first laminating roller and laid onto a second laminating roller, with the liner material facing the second laminating roller; and
by means of a third lay-on roller following in the web direction, the coated second auxiliary carrier material is laid onto the tapelike carrier material, with the second adhesive layer facing the tapelike carrier material; and
by means of a second delaminating device following in the web direction, the second auxiliary carrier material is delaminated from the second adhesive layer.

8. The method of claim 2, wherein
by means of a first lay-on roller, the coated first auxiliary carrier material is laid onto the first laminating roller, so that the first adhesive layer faces away from the laminating roller, and the tapelike carrier material is laid onto the first adhesive layer;
by means of a second lay-on roller following in the web direction, the coated second auxiliary carrier material is laid onto the tapelike carrier material, with the second adhesive layer facing the weblike carrier material;
by means of a first delaminating device following in the web direction, the second auxiliary carrier material is delaminated from the second adhesive layer;
by means of a third lay-on roller following in the web direction, the liner material is laminated onto the second adhesive layer;
by means of a second delaminating device following in the web direction, the first auxiliary carrier material is delaminated from the first adhesive layer.

9. The method of claim 2, wherein
the coated first auxiliary carrier material and the tapelike carrier material are laminated between a first roller pair, so that the first adhesive layer is disposed between the first auxiliary carrier material and the tapelike carrier material;
by means of a second roller pair following in the web direction, the coated second auxiliary carrier material is laminated onto the uncoated surface of the tapelike carrier material, the second adhesive layer being disposed between the second auxiliary carrier material and the tapelike carrier material;
one of the two auxiliary carrier materials is delaminated by means of a first delaminating device following in the web direction;
the liner material is laminated onto the exposed first or second adhesive layer by means of a third roller pair following in the web direction; and
the remaining auxiliary carrier material is delaminated by means of a second delaminating device following in the web direction.

10. The method of claim 2, wherein
in a first method section, a laminate precursor with the layer sequence first auxiliary carrier material/first adhesive layer/tapelike carrier material/second adhesive layer is produced, and the laminate precursor is wound onto a roll; and
in a second method step, the laminate precursor is unwound from the roll, and the liner material is laminated onto the second adhesive layer to give the laminate end product.

11. The method of claim 2, wherein
in a first method section, a laminate precursor with the layer sequence tapelike carrier material/second adhesive layer/liner material is produced, and the laminate precursor is wound onto a roller; and
in a second method step, the laminate precursor is unwound from the roller, and the coated first auxiliary carrier material is laminated onto the uncoated surface of the tapelike carrier material, and the first adhesive layer is delaminated in a delaminating device following in the web direction, to give the laminate end product.

12. The method of claim 1, wherein the tapelike carrier material, prior to its lamination, is subjected to a corona treatment.

13. The method of claim 1, wherein the first adhesive layer and the second adhesive layer may be identical or different.

14. The method of claim 1, wherein the first auxiliary carrier material and the second auxiliary carrier material may be identical or different.

15. The method of claim 1, wherein the first and/or second auxiliary carrier materials are designed such that each can be used multiply.

16. Apparatus for producing a tapelike laminate from a first tapelike auxiliary carrier material, coated with at least one first adhesive layer and wound up onto a first roll, comprising an accommodating device for the first roll, from which the coated first auxiliary carrier material is unwound; a laminating roller; a lay-on roller for laying a tapelike carrier material and the coated first auxiliary carrier material onto the laminating roller; and a first delaminating device for delaminating the first auxiliary carrier material from the first adhesive layer.

17. The apparatus of claim 16, which further comprises an accommodating device for a second roll from which a second auxiliary carrier material, coated with at least one second adhesive layer, is unwound; a lay-on roller for laying-on the coated second auxiliary carrier material; and a second delaminating device for delaminating the second auxiliary carrier material from the second adhesive layer.

18. The apparatus of claim 16, which further comprises a lay-on roller for laying-on a liner material.

19. The apparatus of claim 16, which further comprises in the web direction on the first laminating roller
a first lay-on roller designed for laying the tapelike carrier material and the coated first auxiliary carrier material onto the first laminating roller, so that the tapelike carrier material faces the first laminating roller and the first adhesive layer faces the tapelike carrier material;
the first delaminating device is designed for delaminating the first auxiliary carrier material from the first layer of adhesive; and
a second lay-on roller designed for laminating the liner material onto the first adhesive layer.

20. The apparatus of claim 19, which further comprises a second laminating roller whose rotational direction is opposite to the rotational direction of the first laminating roller, and a laminate precursor, which is guided from the first laminating roller to the second laminating roller, facing, with its liner material, the second laminating roller, and where in the web direction on the second laminating roller
a third lay-on roller is designed for laminating a second auxiliary carrier material, coated with at least one second adhesive layer, onto the tapelike carrier material, so that the second adhesive layer faces the tapelike carrier material; and
a second delaminating device is designed for delaminating the second auxiliary carrier material from the second adhesive layer.

21. The apparatus of claim 16, where in the web direction on the first laminating roller
a first lay-on roller is designed for laying the coated first auxiliary carrier material onto the first laminating roller, so that the first adhesive layer faces away from the first laminating roller, and for laying the tapelike carrier material onto the first adhesive layer;
a second lay-on roller is designed for laminating a second auxiliary carrier material, coated with at least one second adhesive layer, onto the tapelike carrier material, so that the second adhesive layer faces the tapelike carrier material;
a first delaminating device is designed for delaminating the second auxiliary carrier material from the second layer of adhesive;
a third lay-on roller is designed for laminating a liner material onto the second adhesive layer; and
a second delaminating device is designed for delaminating the first auxiliary carrier material from the first layer of adhesive.

22. The apparatus of claim 16, which has in the web direction
a first roller pair, which comprises the first laminating roller and between which the coated first auxiliary carrier material and the tapelike carrier material are laminated, so that the first adhesive layer is disposed between the first auxiliary carrier material and the tapelike carrier material;
a second roller pair, with which a second auxiliary carrier material, coated with at least one second adhesive layer, is laminated onto the uncoated surface of the tapelike carrier material, the second adhesive layer being disposed between the second auxiliary carrier material and the tapelike carrier material;
a first delaminating device, with which one of the two auxiliary carrier materials is delaminated;
a third roller pair, with which a liner material is laminated onto the exposed first or second adhesive layer; and
a second delaminating device, with which the remaining auxiliary carrier material is delaminated.

23. Method of producing an adhesive tape using the apparatus of claim 16.

24. Method of claim 23, which produces a single-sided or double-sided adhesive tape.
